(19) United States
(12) Patent Application Publication
(10) Pub. No.: US 2026/0308783 A1
(43) Pub. Date: Oct. 8, 2026

(54) PRODUCING A STABLE ACTIVATED NICKEL OXIDE HYDROXIDE FOAM ELECTRODE

(71) Applicant: Evonik Operations GmbH, Essen (DE)

(72) Inventors: Siegfried R. Waldvogel, Muelheim an der Ruhr (DE); Roland J. -R. Bednarz, Hochheim am Main (DE); Frank Weinelt, Neuburg am Inn (DE); Ernst Roemer, Dorsten (DE)

(73) Assignee: Evonik Operations GmbH, Essen (DE)

(21) Appl. No.: 19/479,754

(22) PCT Filed: Apr. 30, 2024
(86) PCT No.: PCT/EP2024/061885

§ 371 Date: Oct. 29, 2025

(30) Foreign Application Priority Data
May 2, 2023 (EP) 23171120.1

(51) Int. Cl. C25B 11/075; C25B 1/04; C25B 3/23; C25B 11/031

(52) U.S. Cl. CPC C25B 11/075; C25B 1/04; C25B 3/23; C25B 11/031

(57) ABSTRACT

The invention relates to a process enabling electrochemical activation of metal electrodes and metal foam electrodes, more particularly nickel electrodes and especially nickel foam electrodes. The invention further relates to metal electrodes and metal foam electrodes, more particularly nickel electrodes and especially nickel foam electrodes, obtained by the process for electrochemical activation. In addition, the invention relates to the use of the metal electrodes and metal foam electrodes, more particularly nickel electrodes and especially nickel foam electrodes, electrochemically activated by the process of the invention, in electrochemical reactions, electrolysis of organic compounds, catalysis of organic chemical reactions, and water electrolysis.

The invention relates to a process enabling electrochemical activation of metal electrodes and metal foam electrodes, more particularly nickel electrodes and especially nickel foam electrodes. The invention further relates to metal electrodes and metal foam electrodes, more particularly nickel electrodes and especially nickel foam electrodes, obtained by the process for electrochemical activation. In addition, the invention relates to the use of the metal electrodes and metal foam electrodes, more particularly nickel electrodes and especially nickel foam electrodes, electrochemically activated by the process of the invention, in electrochemical reactions, electrolysis of organic compounds, catalysis of organic chemical reactions, and water electrolysis.

Metal electrodes and metal foam electrodes, more particularly nickel electrodes and especially nickel foam electrodes, are in high demand in extensive fields of use, on account of their high porosity, conductivity, mechanical stability and chemical resistance.

The only process known to date in the prior art for activating nickel foam electrodes is an electrocatalytic process based on changing polarity of two nickel electrodes. This activation operates using solutions of 0.05 M-0.1 M NiSO₄(aq) and 0.1 M NaOAc(aq) or 0.1 M KOAc(aq), with addition of base in concentrations of 10⁻⁵ M to 1 mM KOH(aq) or 5 mM NaOH(aq) (G. W. D. Briggs, E. Jones, W. F. K. Wynne-Jones, Trans. Faraday Soc. 1955, 51, 1433-1442; B. V. Lyalin, V. A. Petrosyan, Russ. Chem. Bull. 2004, 53, 688-692; W. Jud, C. A. Salazar, J. Imbrogno, J. Verghese, S. M. Guinness, J.-N. Desrosiers, C. O. Kappe, D. Cantillo, Org. Process Res. Dev. 2022, 26, 1486-1495, H.-J. Schafer, J. Kaulen, Tetrahedron 1982, 38, 3299-3308). In all known cases, the activation requires a change in polarity between two nickel electrodes every 5 to 30 seconds, where indicated in more detail.

A disadvantage of this known activation method is its low reproducibility, especially for cleaned nickel foam electrodes. Particularly for nickel foam electrodes cleaned after electrochemical oxidations, the conventional activation method thus does not lead reproducibly to stable nickel oxyhydroxides.

Moreover, it is necessary to use a polarity changer. This significantly broadens the complexity for the electronic periphery of the usually galvanostatic set-up. Furthermore, two nickel electrodes are required, although only one is used for the subsequent electrochemical reaction. Half of the nickel species deposited, therefore, are accounted for by an electrode which is not employed in the reaction, since only the ultimately anodically polarised electrode carries an outer layer of NiO(OH).

It is an object of the present invention to provide a process for activating metal electrodes that does not exhibit the disadvantages of the process known from the prior art for activating metal electrodes and metal foam electrodes, more particularly nickel electrodes and especially nickel foam electrodes, or only exhibits such disadvantages in a diminished form.

This object has been achieved by the subject matter of the claims and of the description.

The present invention relates to a process for the electrochemical activation of metal electrodes, comprising the steps of
(a) pretreating the metal electrode by contacting the metal electrode with base and
(b) electrochemically activating the metal electrode pretreated as per step (a) without reversal of polarity of the metal electrode with formation of an outer metal oxyhydroxide layer,
wherein the metal electrode includes 0% to 100% by weight of nickel and 100% to 0% by weight of cobalt, based in each case on the total content of nickel and cobalt in the electrode, or includes 10% to 100% by weight of nickel and 0% to 90% by weight of iron, based in each case on the total content of nickel and iron in the electrode, wherein the metal electrode includes a content of other metals of equal to or less than 10% by weight, based in each case on the total metal content.

The process of the invention permits efficient activation of a single metal electrode, more particularly a nickel electrode or nickel foam electrode, in undivided form and in direct current, without requiring reversal of polarity of two metal electrodes, more particularly two nickel electrodes. When the process of the invention is used there is no need for a polarity changer, thus simplifying the set-up of the facility.

In addition, the process of the invention allows in particular for reproducible activation of metal foam electrodes, more particularly nickel foam electrodes, after they have been used in electro-organic oxidations. Since the cleaning of foam electrodes is more difficult by comparison with plate electrodes, the existing method for activating them appeared to be less suitable. They cannot simply be polished, as is the case for plate electrodes.

Accordingly, the process claimed in the invention affords very good access to electrochemically activated nickel surfaces, with enhanced reproducibility when using cleaned nickel foams or nickel foam electrodes. In particular, the process of the invention allows reproducible electrochemical activation of (cleaned) nickel foams and nickel plate electrodes. This may extend the lifetime of the electrodes, depending on the extent of the fouling.

Activated nickel foams are elemental to successful electrochemical oxidation of numerous substances, including (a)cyclic alcohols and ketones (H.-J. Schafer, Electrochemistry I, Top. Curr. Chem. 1987, 142, 101-129). The present invention therefore allows a flexible and simplified method for activating nickel foams.

A further advantage of the process of the invention is deemed to be the need only for very small volumes of a base in the wetting of the metal electrode, more particularly the nickel electrode, and also the possibility of using the base employed continuously for this purpose. Further advantages lie in the flexibility of using different activating solutions, in the suitability of the reaction conditions for industrially relevant scaling of the electrochemical activation, and in the possibility of using the large activated nickel surface for various applications, in catalysis or in electrolysis/battery technology, for example.

Lastly, the process of the invention also allows used nickel foams to be employed for electro-organic oxidations on activated nickel surfaces. Direct-current electrochemical activation allows for rapid and controlled activation and obviates the nickel residues deposited on the second electrode.

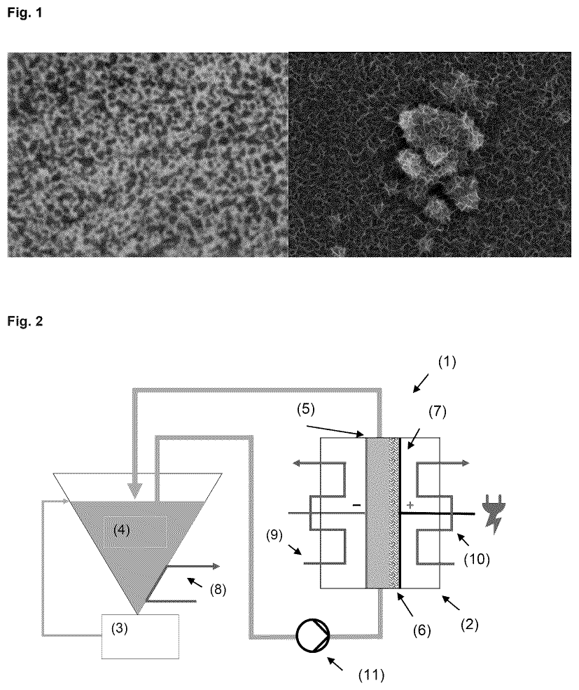

FIG. 1 shows on the left a scanning electron micrograph (SEM) of the nickel oxyhydroxide surface activated using the conventional activation method (taken from G. W. D. Briggs, E. Jones, W. F. K. Wynne-Jones, Trans. Faraday Soc. 1955, 51, 1433-1442) and on the right an SEM micrograph of the activated surface obtained by the process of the invention. A fibre network of fine porosity is evident in both cases.

For nickel foams cleaned after electrochemical oxidations, therefore, the conventional activation method did not lead reproducibly to stable nickel oxyhydroxides. This was already apparent purely visually, from the absence of blackening.

FIG. 2 illustrates a flow electrolysis cell for performing a process using an electrochemically activated metal electrode in accordance with the present invention.

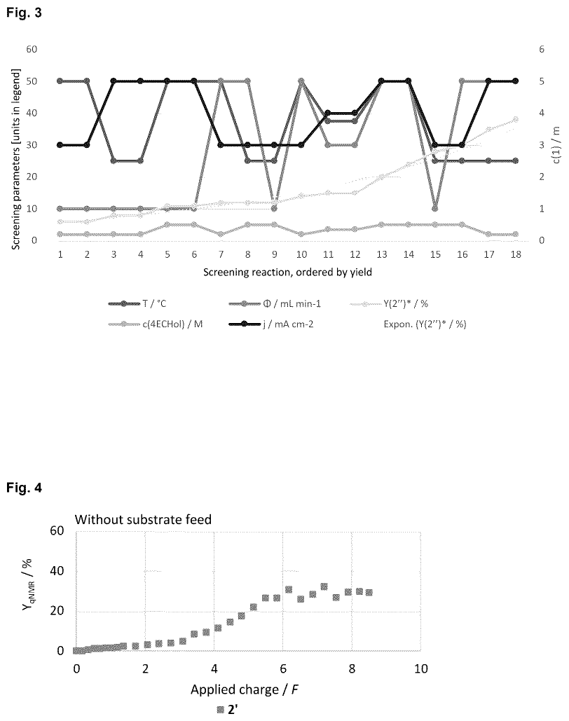

FIG. 3 shows a graphical evaluation of the parameter results with a plot corresponding to the qNMR yields of 3-ethyladipic acid after the electrochemical oxidation of 4-ethylcyclohexanol using an electrochemically activated metal electrode in accordance with the present invention.

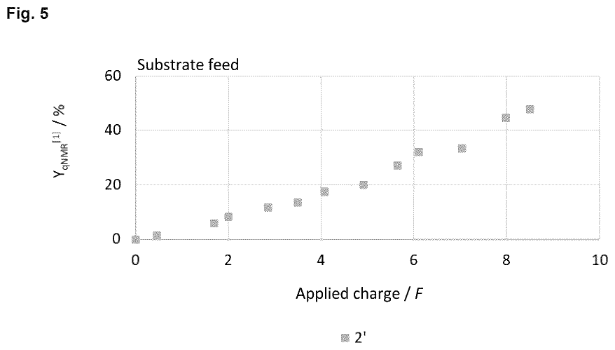

FIGS. 4 and 5 illustrate the qNMR yield change of 3-propyladipic acid without and with supply of 4-propylcyclohexanone versus the charge applied using an electrochemically activated metal electrode in accordance with the present invention.

The contacting of the metal electrode with base has a dual function: First, it cleans the surface and second it accelerates rapid formation of a metal oxyhydroxide layer, more particularly a nickel oxyhydroxide layer, at the surface.

For more extensive oxidation reactions on correspondingly electrochemically activated metal oxyhydroxide anodes, more particularly nickel oxyhydroxide anode (Ni(O)OH), it may be advantageous to choose a basic environment, such as dilute sodium hydroxide solution, for example, as the electrolyte, in order to keep the catalyst active during the reaction.

The content of other metals in the metal electrode is preferably not more than 5% by weight, very preferably not more than 2% by weight and even further preferably not more than 1% by weight, based in each case on the total metal content.

The metal electrode preferably contains not more than up to 1% by weight in each case, more preferably not more than up to 0.1% by weight in each case and even further preferably not more than 0.01% by weight in each case of V, W and Mo. It should be noted that these metals are subject to corrosion particularly in alkaline-aqueous emulsions.

Useful metal electrodes in the process of the invention are more preferably those that include at least 80% by weight, preferably at least 90% by weight, more preferably at least 95% by weight of nickel, based in each case on the total weight of the metals in the electrode.

The metals nickel and/or cobalt and optionally iron may be present in the metal electrode on a substrate, where the substrate is especially at least one material selected from the group consisting of steel, copper, titanium and carbon, preferably graphite.

The metal electrode may preferably have been doped with at least one element from main group 5 and/or 6, more preferably with one or more elements, preferably one element, selected from the group consisting of phosphorus, arsenic, selenium and sulfur.

The figures for the doping content refer to the elemental state of the doping, based on the mass of metal of the electrode.

If the metal electrode has been doped with phosphorus, it may preferably include 2% to 10% by weight of phosphorus, more preferably 3% to 9% by weight and most preferably 4% to 9% by weight, where phosphorus is considered in elemental form in each case and is based on the mass of metal in the electrode.

The phosphorus dopant content can preferably be determined in accordance with DIN EN ISO 5427, Appendix D.1.

The metal electrode preferably has a thickness of two or more millimetres, more preferably more than 3 mm, even more preferably more than 5 mm, and is especially preferably no thinner than 6 mm.

The metal electrode used in the process according to the invention is preferably an Ni(O)OH foam electrode that preferably contains nickel at least to an extent of 80% by weight, more preferably at least 85%, 90%, 95%, 98% or 99% by weight, even more preferably at least 99.9% and even further preferably at least 99.99% by weight, based in each case on the metal content of the Ni(O)OH foam electrode.

The metal electrode is preferably pretreated by being contacted with base, preferably at least one inorganic base and/or at least one organic base.

Customary inorganic and organic bases known to the skilled person are suitable for use for the contacting step. Preference is given to the use of one or more bases, preferably one base, selected independently from one another from the group consisting of N(R^{A})₄OH, N(R^{A})₄ acetate, where each R^{A} is independently H or C₁₋₄-alkyl, linear or branched, NaOH, sodium acetate, KOH, potassium acetate, LiOH, lithium acetate, Na₂CO₃, K₂CO₃ and Li₂CO₃, more preferably selected from the group consisting of NaOH and KOH.

The base is preferably used in aqueous solution in the contacting step, where the concentration of the base is preferably 10 mM to 10 M, more preferably 0.2 to 5 M, even more preferably 0.5 to 1.5 M and still further preferably 1±0.1 M.

The metal electrode can be contacted with base especially by spray application, dipping, jetting or in a flow system.

The metal electrode and the base may be contacted with one another over a relatively wide temperature range. The metal electrode is preferably contacted with base at a temperature of 10 to 40° C., more preferably at 18 to 27° C.

According to the process of the invention, it is advantageously possible to conduct the electrochemical activation of the metal electrode, wherein, in particular, one or more salts of nickel and/or cobalt and optionally iron are suitable for this step.

If salts of nickel or cobalt are used, suitable salts are especially those selected from the group consisting of Ni₂SO₄ and CoSO₄.

For electrochemical activation of the metal electrode, the salt or salts may preferably be in basic aqueous solution, preferably in a concentration of 0.05 to 0.15 M.

Useful bases here are customary bases known to the skilled person. Preference is given to the use of one or more bases, especially one base, selected independently from one another from the group consisting of N(R^{A})₄OH, N(R^{A})₄ acetate, where each R^{A} is independently H or C₁₋₄-alkyl, linear or branched, NaOH, sodium acetate, KOH, potassium acetate, LiOH, lithium acetate, Na₂CO₃, K₂CO₃ and Li₂CO₃, more preferably selected from the group consisting of NaOH and KOH.

The concentration of the base in the electrochemical activation of the metal electrode is preferably 10 mM to 10 M, preferably 0.2 to 5 M, more preferably 0.5 to 1.5 M, most preferably 1±0.1 M.

The metal electrode is preferably activated with an amount of charge of 2 to 10 coulombs, preferably 5 to 7 coulombs.

The metal electrode can be electrochemically activated over a wide temperature range. The metal electrode is preferably activated at a temperature of 10 to 40° C., more preferably at 18 to 27° C.

The present invention further relates to an electrochemically activated metal electrode more particularly obtainable by the process of the invention.

The present invention further relates to an electrochemically activated metal electrode, more particularly obtainable or obtained by the process of the invention, for performing oxidation reactions of organic components, for water electrolysis, in batteries or in catalysis.

The metal electrode electrochemically activated by the process of the invention may be employed preferably in a batch electrolysis cell or in an electrolysis cell through which there is continuous flow, preferably in an electrolysis cell through which there is continuous flow.

The metal electrode electrochemically activated by the process of the invention may be used preferably in an undivided electrolysis cell.

The following examples further elucidate the present invention but are not intended to limit the scope of the invention.

### EXAMPLES

### General Information and Methods

Chemicals of analysis quality were used as sourced from the usual suppliers (such as TCI, Aldrich, Rotisolv, Fisher Chemical, VWR, Thermos scientific and Acros). Solvents were purified by standard methods such as distillation or demineralization.

Reaction conditions used, unless stated otherwise, were ambient pressure and ambient temperature.

The electrodes employed for the reactions were commercially available and contain small channels on the inlet and outlet sides: Stainless steel (1.4571) and Recemat™ nickel foam. They fit with the IKA ElectraSyn flow 6-18 setup. For the activation, a separate sheet metal electrode (6×18 cm²) was cut from stainless steel (1.4571) from the university workshop. The galvanostat used was a TDK Lambda Genesys 750 W/1500 W power supply. The reaction mixture was pumped through Ismapren hoses (size 16) using a Reglo Digital Masterflex™ peristaltic pump (model no. 78018-42) from Ismatec. A heating circuit was installed and connected to an IKA WICO CBC 5 C cooling and circulation thermostat (model: RN41).

Melting point determination: Melting points were determined with an M-565 device (Buchi, Essen, Germany). The heating rate was 1° C. per minute.

NMR spectroscopy: A Bruker Avance III 600 (Bruker, probe head: 5 mm TCI-CryoProbe head with z gradient and ATM) NMR spectrometer was used in order to record ¹H (600 MHz) and ¹³C (151 MHz) inverse-gated spectra at 25° C. Chemical shifts (6) are reported in parts per million (ppm). Quantification was effected by integration of the respective signals in the ¹³C inverse-gated spectrum versus 1,3,5-trimethoxybenzene as internal standard (δ=(55.4±0.02) ppm). The reference used was the DMSO-d6 signal (δ=39.52 ppm).

Liquid chromatography: The photodiode array analysis was conducted using a Shimadzu DUGA-20A3 instrument equipped with a Knauer C18 column (Eurospher II, 100-5 C18, 150×4 mm). The column was conditioned at 25° C. and the flow rate was adjusted to 1 ml/min. The aqueous eluent was buffered with formic acid (0.8 ml/2.5 l) and stabilized with acetone (5% by volume). The samples were produced by extracting the carboxylic acid product mixture from the reaction mixture by acid-base extraction with ethyl acetate, drying over MgSO₄ and evaporating the solvent. The product was filtered (VWR 13 mm syringe filter with 0.45 μm PTFE membrane), dissolved and diluted in acetonitrile (MS quality). This organic solution was analysed by liquid chromatography.

High-resolution mass spectra were obtained using a G6545A Q-ToF (Agilent GmbH, Waldbronn, Germany) with a dual AJS electrospray ion source (dual AJS ESI). The MS parameters were as follows: Mass range: 80 to 3200 m/z, scan rate: 1 spectrum s⁻¹, atomizer pressure: 25 psig, capillary voltage: 3500 V, fragmenter: 50 V, skimmer: 45 V, dry gas temperature: 275° C., dry gas flow rate: 10 l min⁻¹, sheath gas temperature: 350° C., sheath gas flow rate: 10 l min⁻¹. The mass calibration was conducted with an external standard on the day of measurement. The mass accuracy of the measurement results is better than 5 ppm. The chromatography separation was conducted on a 1260 lnfinity II HPLC system (Agilent GmbH, Waldbronn, Germany) with G7111B 1260 quaternary pump, G7129A 1260 vial sampler and G7116A 1260 multicolumn thermostat, equipped with an Agilent EclipsePlus C18 RRHP (2.1×50 mm, 2.1 μm particle size) analytical column. Eluents were 98% H2O with 2% ACN and 0.05% formic acid (eluent A) and 2% H2O with 98% ACN and 0.05% formic acid (eluent B). The following gradient elution was employed for separation at a flow rate of 200 μl min⁻¹: Beginning at 10% B for 1 min, followed by a linear increase to 95% B at 10 min, retention of 95% B to 30 min, before returning to 10% B at 33 min. The column was equilibrated at 10% B before the next measurement for 15 min. The injection volume was 2 μl. The data were recorded with the Agilent MassHunter Workstation LC/MS software, version 11.0, and the data analysis was conducted with the Agilent MassHunter Workstation Qualitative Analysis software, version 10.0.

MALDI TOF MS: The Autoflex MALDI TOF mass spectrometer from Bruker Daltonik GmbH (Fahrenheitstrasse 4, 28359 Bremen, Germany) with a Smartbeam™II Nd:YAG laser (355 nm) was used. The image was measured in linear mode. The matrix used was 2-[(2E)-3-(4-tert-butylphenyl)-2-methylprop-2-enylidene]malononitrile (DCTB).

In accordance with the description below, an electrolysis cell with electrochemically activated nickel anode was produced and used in the subsequent reactions.

A flow electrolysis cell having a geometric anodic surface area of 108 cm² was used (FIG. 2). The modular construction of the cell, further comprising a self-supporting frame and a cage for the foam electrode—all with an active geometric surface area of 108 cm²—mean that this electrolyser is of particular interest for upscaled electrolyses in flow mode. Moreover, major dissipation of heat through channels behind the electrodes is enabled, which enables better control of temperature than in smaller commercial flow electrolysers where only the reservoir can be adjusted to a particular temperature.

FIG. 2 shows the scheme of the reaction set up in an undivided flow electrolysis cell with a stainless steel cathode and nickel foam anode contacted by a nickel-plated electrode. The distance between the electrodes was 3 mm. The cooling circuit used water for temperature control between 25 and 50° C. The reaction mixture was emulsified with an IKA Magic lab mixing unit with DR mixing element (IKA-Werke GmbH & Co. KG, Staufen, Germany).

### Activation of the Nickel Anode:

First of all, an activation solution was produced consisting of 0.1 M NiSO₄(aq), 0.1 M NaOAc(aq) and 5 mM NaOH(aq). This activation solution (420 ml) was introduced into a beaker-shaped cell made of polymethylmethacrylate (PMMA). A stainless steel electrode (6×18 cm) was immersed and connected. Before the complete immersion and connection of the nickel foam anode at a distance of 10 mm, it was dipped in 1 M sodium hydroxide solution or rinsed thoroughly therewith and then allowed to drip dry. A current density of 5.0 mA cm⁻² was applied for 30 min. This corresponds to a charge of 9 C cm⁻². The activation solution was stirred at 300 rpm. Subsequently, the activated dark-coloured nickel foam was rinsed with demineralized water. The stainless steel cathode was cleaned by briefly immersing in dilute sulfuric acid (4 M), then washed with water and treated with abrasive paper (300 grit) until it had a visually homogeneous shine. Then the cell was set up again. Although SEM images showed that the cleaning process did not fully re-establish the original surface morphology, the above-described activation method was also employable successfully on the cleaned nickel foams.

### Performance of the Flow Cell Electrolysis:

The commercially available modular IKA ESF 6-18 flow electrolyser was used, as described above. This was undivided with a nickel foam anode (Recemat™ RCM-Ni4753.05), connected by a nickel sheet, and a stainless steel cathode (1.4571), each with dimensions of 6×18 cm². A polytetrafluoroethylene (PTFE) spacer (0.4 mm) was used. The nickel foam anode was activated as described above.

The commercially available IKA magic LAB® mixing unit was connected to the IKA magic PLANT® stirred vessel. The electrolyte, consisting of NaOH(aq) (1 M) and the respective cyclic 4-alkylcyclohexanol reactant (1), was emulsified therein. This mixing unit has a high-performance DR mixing element and pumps the liquid cyclically into the reservoir vessel and thence back again. This flow rate is 12 000 rpm (corresponding to about 70 l per hour). A peristaltic pump feeds the upright flow cell therefrom, from the bottom. Tubes on the output side are connected to the reservoir vessel, as a result of which the hydrogen formed can be reliably removed. A defined amount of charge and current density were applied and monitored, using a Python software controller and the TDK Lambda Genesys galvanostat. After the electrolysis had ended, the reaction mixture was pumped out of the electrolyser in reverse flow direction. Then methyl tert-butyl ether (MTBE, 80 ml) and 1 M sodium hydroxide solution (80 ml) were used in order to successively clean the cell. All fractions were combined and worked up by liquid-liquid extraction in a 2 l perforator.

Non-acidic components were first extracted from the basic aqueous reaction mixture with MTBE. After acidification to pH 1-2, the acids were extracted with ethyl acetate. The organic fractions were dried over MgSO₄ and the solvents were removed. The remaining acid fraction was weighed, and the products were analysed quantitatively by ¹³C inverse-gated NMR spectroscopy. The internal standard used was 1,3,5-trimethoxybenzene (0.1 mmol).

### Example 1

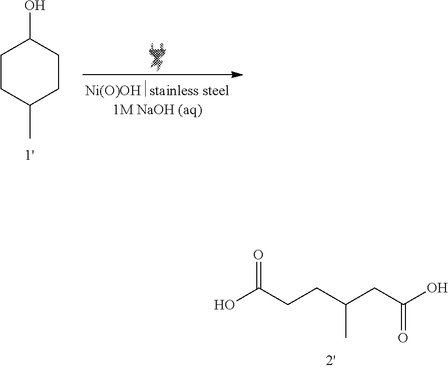

An anodic oxidation of 4-methylcyclohexanol (1′) to 3-methyladipic acid (2′) was conducted in the above-described flow cell.

4-Methylcyclohexanol oxidation: 4-Methylcyclohexanol (1′, 10 mmol, c=0.1 M, isomer mixture) was mixed with sodium hydroxide solution (1 M) in a beaker (V=100 ml). The cell was kept at a temperature of 50° C. with an external IKA-HBC-5 thermostat. The reaction mixture was pumped through the electrolyser at a flow rate of 61 ml min⁻¹. The current density applied was set to 5.0 mA cm⁻², and a total charge of 8.0 F was used. After the reaction, the product mixture was collected, tert-butyl methyl ether was pumped through the cell, and an acid-base extraction was conducted. For this purpose, the basic reaction medium was extracted three times with tert-butyl methyl ether (100 ml each time), acidified to pH 1-2 with 4.5 M sulfuric acid and extracted four times with ethyl acetate (100 ml each time). After drying over MgSO4 and subsequent removal of the solvent, the product mixture was analysed by 1H and 13C inverse-gated NMR versus 1,3,5-trimethoxybenzene as internal standard.

### Example 2

First of all, 4-ethylcyclohexanol was synthesized by the method that follows. 4-Ethylphenol (100 g, 0.82 mol) was dissolved in methanol (500 ml), ruthenium/charcoal (10 g, 5% Ru on C) was added to the 1 litre autoclave, and a hydrogen atmosphere (10 bar) was applied. The autoclave was set to a temperature of 120° C. The yield of 4-ethylcyclohexanol (1″) was monitored by taking samples (0.1 ml of the reaction medium) daily. The formation of product was monitored by gas chromatography, and the reaction was stopped when no further formation of product was observed. 4-Ethylphenol was purchased from Sigma Aldrich, ruthenium from Heraeus Chemicals. 4-Ethylcyclohexanol (1″) was synthesized on a 200 g scale with isolated yields of up to 95% after vacuum distillation.

This was followed by the electrochemical oxidation of 4-ethylcyclohexanol to 3-ethyladipic acid according to Scheme 1 below:

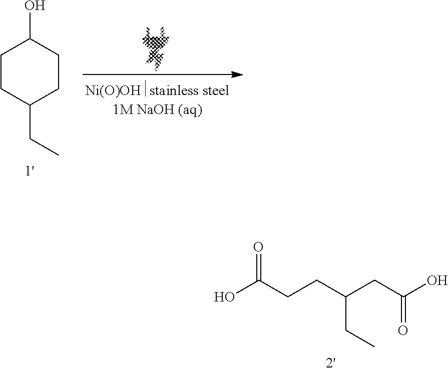

The oxidation here was subjected to a design-of-experiment screening method with regard to the parameters of reaction temperature, flow rate, concentration of the cyclic reactant and current density. Here too, a previously activated nickel foam anode and a V5A stainless steel plate cathode were used. The reaction is effected in a semistable emulsion of the cyclic reactant with 1 M NaOH(aq), since the two liquids are immiscible under standard conditions.

For the performance of the screening method, a Masterflex™ PharMed™ BPT setup, L/S 16, tubing for long-term use, was installed. Pumping was accomplished using a Masterflex™ Ismatec™ 78018-42 peristaltic pump. Continuous mixing was accomplished using an IKA Magic Lab/IKA Magic Plant System with a DR mixing element (IKA-Werke GmbH & Co. KG Staufen, Germany). In all experiments, the mixing system worked at 12 000 rpm (circulation rate≈70 l h⁻¹) in order to achieve an optically semistable emulsion for the period of pumping through the flow electrolyser and back into the mixer. For all reactions, a charge of 9 F was used.

The reaction mixture was worked up as follows: After each experiment, the reaction mixture was collected in a vial, and tert-butyl methyl ether (50 ml) was pumped through the electrolyser in cycle mode for 1 minute in order to minimize losses. The same thing was done with 1 M sodium hydroxide solution (50 ml). Thereafter, an acid-base extraction was conducted with a Ludwig perforator. It is more easily possible to achieve high stirrer speeds if a small stirrer bar is used. In addition, the solvent should be replenished in the main compartment. The yellow basic reaction mixture was extracted with MTBE overnight. Subsequently, the two phases were separated, and the aqueous layer was acidified to pH 1-2 with 4.5 M H₂SO₄(aq). The neutralized crude product was then extracted in a perforator with ethyl acetate. The two organic fractions were dried over MgSO₄, the solvent was removed under low pressure, and the product was analysed by 13C inverse-gated NMR with 1,3,5-trimethoxybenzene as internal standard.

For isolation, the resultant carboxylic acid mixture was distilled under reduced pressure through a Vigreux column at 10⁰-10⁻² mbar. The main product was distilled at 180-220° C. The remaining yellow colour could be removed by recrystallization from heptane. If ethyl esters of 3-ethyladipic acid were present, the product mixture was dissolved in sodium hydroxide solution (3 M), heated to 80° C. and stirred vigorously for 3 hours. Then the mixture was extracted in a sufficiently large separating funnel with tert-butyl methyl ether (3× one third of the aqueous volume), acidified to pH 2-3 with H₂SO₄(aq) (4.5 M) and extracted with ethyl acetate. The organic fraction was dried over MgSO₄, and after the solvent was removed, the crystals were obtained. A second recrystallization appeared to lead to a higher purity.

For the parameter DoE screening, four parameters were varied: the concentration of the cyclic reactant c, the reaction temperature T, the flow rate of the reaction medium φ, and the current density j, with reproduction of the corresponding parameter limits in Table 1 below. As well as the parameter limits set, central point tests were also conducted. All experiments were repeated once in order to determine the reproducibility of the reactions, and the reaction sequence of these 18 chemical experiments was randomized. The reaction took between 0.9 and 2.3 days. Quantitative NMR yields of nearly 40% were achieved for the target product (2″). The maximum isolated yield was 39%. The nickel foam anode was reused for all the reactions reported here, which reduced the waste stream.

TABLE 1
Parameters of the DoE screening. The geometric current density is based on the
current relative to the geometric anodic surface area of the anodic foam - 108 cm². Reaction
conditions: 1 M NaOH(aq), water, activation = 7.5 mA cm⁻² (geometric current density),
activation = 10 C cm⁻², 9 F. The flow rate of the reaction Φ is a cumulative flow rate through
the two tubes. Each parameter has three data points.

| Parameter | Lower limit | Median value | Upper limit |
|---|---|---|---|
| Temperature of the | 25.0° C. | 37.5° C. | 50.0° C. |
| reaction mixture, T | | | |
| Concentration of 4- | 0.2 M | 0.35 M | 0.5 M |
| ethylcyclohexanol, c | | | |
| Flow rate of the | 10 ml min⁻¹ | 30 ml min⁻¹ | 50 ml min⁻¹ |
| reaction, Φ | | | |
| Geometric current | 3 mA cm⁻² | 4 mA cm⁻² | 5 mA cm⁻² |
| density, j | | | |

It has been found that the flow rate and concentration of the reactant have the greatest influence on the yield of desired product. Higher flow rates, especially of 30 to 50 ml min⁻¹, and lower concentrations of the reactant, especially of 0.2 to 0.35 M, have a positive effect on the yield of 3-ethyladipic acids.

The analysed product spectrum of the oxidation of 4-ethylcyclohexanol examined is shown below:

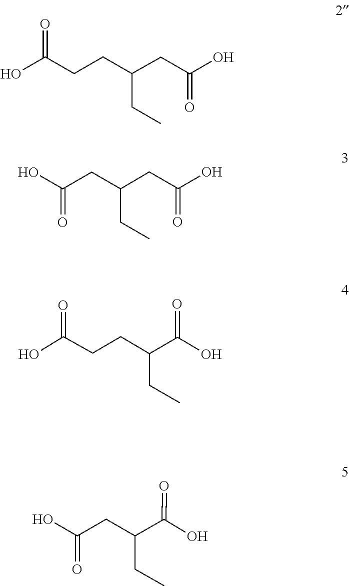

Structures of 3-ethyladipic acid (2″), 3-ethylglutaric acid (3), 2-ethylglutaric acid (4) and ethylsuccinic acid (5).

A graphical evaluation of the parameter results with a plot corresponding to the qNMR yields of 3-ethyladipic acid (2) is shown in FIG. 3. The tested parameters are reaction temperature T (25° C., 37.5° C. and 50° C.), flow rate of the reaction mixture φ (10 ml min⁻¹, 30 ml min⁻¹ and 50 ml min⁻¹), concentration of 4-ethylcyclohexanol c(1) (0.2 m, 0.35 m and 0.5 m) and applied reaction current density j (3.0 mA cm⁻², 4.0 mA cm⁻² and 5.0 mA cm⁻²).

The screening showed that a particular combination of the four parameters tested leads to the highest yields, namely a flow rate of 50 ml min⁻¹, a reaction temperature of 25° C., a current density j of 5.0 mA cm⁻² and a reactant concentration of 0.2 mol/I. It is thus possible to achieve yields of the desired product (2″) of well over 30%.

With these parameters, the best quantitative NMR yields of the products were found to be the following:

$$YqNMR ( 3 - ethyladipic acid ) = 38 \%$$

$$YqNMR ( 3 - ethylglutaric acid ) = 4 \%$$

$$YqNMR ( 2 - ethylglutaric acid ) = 4 \%$$

$$YqNMR ( ethylsuccinic acid ) = 1 \% .$$

After the workup process, 2″ was isolated with a yield of 38%. This is the most efficient isolation of 2″ after an electrochemical synthesis that has been reported to date.

### Characterization of 3-ethyladipic acid (2″)

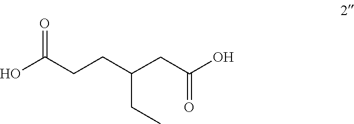

2″ was synthesized electrochemically by the process described above from 4-ethylcyclohexanol (6.41 g, 50 mmol, 0.2 M). The product 2″ was obtained as a pale yellow crystalline solid by acid-base extraction, vacuum distillation and recrystallization from n-heptane (3.31 g, 19 mmol, 38%).

¹H NMR (600 MHz, DMSO-d6): δ [ppm]=12.04 (s, 2H), 2.18 (t, J=7.9 Hz, 2H), 2.12 (d, J=6.9 Hz, 2H), 1.68 (hept, J=6.5 Hz, 1H), 1.57-1.42 (m, 2H), 1.33-1.21 (m, 2H), 0.81 (t, J=7.5 Hz, 3H).

¹³C NMR (151 MHz, DMSO-d6): δ [ppm]=174.75, 174.29, 38.07, 35.41, 31.20, 28.17, 25.63, 10.69.

Melting point: (47.4-49.8° C.)

HRMS (ESI+) m/z: calculated for C8H1404+H+175.0965 [M+H+]+, found: 175.0965.

### Example 3

An anodic oxidation of 4-propylcyclohexanol to 3-propyladipic acid was conducted in the above-described flow cell, and the evolution of the yield of the 3-propyladipic acid in the course of the reaction was analysed.

FIG. 4 shows the change in qNMR yield of 3-propyladipic acid versus the charge applied. The qNMR yield was analysed versus the 1,3,5-trimethoxybenzene standard.

The formation of 3-propyladipic acid was affected by the formation of 4-propylcyclohexanone. The production rate of 3-propyladipic acid was at its greatest 1 F after the maximum available concentration of 4-propylcyclohexanone. The end result was a yield of more than 30%.

Thereafter, the reaction regime was altered such that 4-propylcyclohexanone was present in as stable as possible a concentration in order that the production rate of 3-propyladipic acid was kept constant. For this purpose, the reactant was fed in constantly, matched to the rate of production of 3-propyladipic acid.

Surprisingly, a high yield of the desired product was observed here too. This procedure thus has a positive effect on the yield and also enables a continuous reaction regime.

The change in qNMR yield of 3-propyladipic acid with feeding of 4-propylcyclohexanone versus the charge applied is shown in FIG. 5.

### LIST OF REFERENCE NUMERALS

1 flow electrolysis cell
2 self-supporting frame and cage for the electrode
3 mixer
4 emulsion
5 stainless steel electrode
6 nickel foam electrode
7 nickel plate electrode
8 cooling circuit
9 cooling circuit
10 cooling circuit
11 pump

1. A process for the electrochemical activation of a metal electrode, the process comprising:
(a) pretreating the metal electrode by contacting the metal electrode with base, and
(b) electrochemically activating the metal electrode pretreated as per (a) without reversal of polarity of the metal electrode with formation of an outer metal oxyhydroxide layer,
wherein the metal electrode includes 0% to 100% by weight of nickel and 100% to 0% by weight of cobalt, based in each case on a total content of nickel and cobalt in the metal electrode, or includes 10% to 100% by weight of nickel and 0% to 90% by weight of iron, based in each case on a total content of nickel and iron in the metal electrode, wherein the metal electrode includes a content of other metals of equal to or less than 10% by weight, based in each case on a total metal content.

2. The process according to claim 1, wherein the metal electrode includes a content of other metals of equal to or less than 5% by weight, based in each case on the total metal content.

3. The process according to claim 1, wherein the metal electrode is an Ni(O)OH foam electrode, wherein the Ni(O)OH foam electrode contains nickel as metal.

4. The process according to claim 1, wherein the metal electrode is pretreated by contacting with base, at least one inorganic base and/or at least one organic base.

5. The process according to claim 4, wherein the base is used in aqueous solution.

6. The process according to claim 1, wherein the metal electrode is contacted with the base at a temperature of 10 to 40° C.

7. The process according to claim 1, wherein in the electrochemical activation of the metal electrode pretreated as per (a), one or more salts of nickel and/or cobalt and optionally iron are used.

8. The process according to claim 7, wherein the on or more salts are in aqueous basic solution, wherein one or more bases are selected independently from one another from the group consisting of N(R^{A})₄OH, N(R^{A})₄ acetate, where each R^{A} is independently H or C₁₋₄-alkyl, linear or branched, NaOH, sodium acetate, KOH, potassium acetate, LiOH, lithium acetate, Na₂CO₃, K₂CO₃ and Li₂CO₃.

9. The process according to claim 7, wherein the metal electrode is electrochemically activated at a temperature of 10 to 40° C.

10. The process according to claim 7, wherein the metal electrode is electrochemically activated with an amount of charge of 2 to 10 coulombs.

11. An electrochemically activated metal electrode, obtainable by a process according to claim 1.

12. A method, comprising:
oxidizing of organic components with the metal electrode according to claim 11.

13. A method, comprising:
electrolyzing water with the electrochemically activated metal electrode according to claim 11.

14. A battery, comprising:
the electrochemically activated metal electrode according to claim 11.

15. A method, comprising:
performing catalysis of organic chemical reactions,
wherein, in the method, the electrochemically activated metal electrode according to claim 11 is used.
